(19) United States
(12) Patent Application Publication
(10) Pub. No.: US 2007/0204143 A1
(43) Pub. Date: Aug. 30, 2007

(54) Data transmission device and method thereof

(76) Inventors: Tse-Hsine Liao, Taipei Hsien (TW); Ju-Yi Hung, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/790,703

(22) Filed: Apr. 27, 2007

Related U.S. Application Data
(62) Division of application No. 11/148,279, filed on Jun. 9, 2005.

(51) Int. Cl. G06F 9/00

(52) U.S. Cl. 713/2

(57) ABSTRACT

A data transmission device and a method for the same are proposed. The data transmission device has a first storage device, a second storage device and a transmission control unit controlling the data transfer between a chip set, the first storage device and the second storage device. When the data transfer is performed, the transmission control device checks whether a destination device completely receives the data sent. If positive, the destination device receives the data immediately. Otherwise, a portion of the data is first sent to the destination device and a remaining portion is temporarily stored in the second storage device. Thus, using the transmission control unit improves the transmission efficiency. Furthermore, via storing booting data in the second storage device and using a PCI-Express (PCI-E) interface for data transfer, booting a computer by accessing the data of the second storage device reduces the booting time.

### RELATED APPLICATIONS

This application is a Divisional Patent Application of co-pending application Serial Ser. No. 11/148,279, filed on 9 Jun. 2005.

### BACKGROUND OF THE INVENTION

1. Field of the Invention

The present invention is related to a data transmission device and a method thereof, and more particularly, to a data transmission device connecting a chip set with storage devices inside a computer. The present invention is also applied for speedily booting the computer.

2. Description of Related Art

Reference is made to FIG. 1, which is a block diagram of a conventional computer. The central processing unit (CPU) 70 accesses data from a memory unit 74 via a North-Bridge chip 71 and communicates with peripheral devices via a South-Bridge chip 72. The South-Bridge chip 72 connects with the external peripheral devices via a PCI interface 721, an IDE interface 722 or an input/output chip 73. In general, peripheral devices connected with the input/output chip 73, such as a floppy disk, a keyboard, a mouse or a joystick, have a slow data transmission rate. Further, peripheral devices having a higher transmission rate are connected with the PCI interface 721 and the IDE interface 722. For example, the peripheral device can be a display card or an Ethernet card connected with the PCI interface 721, or a hard disk or optical drive connected with the IDE interface 722.

For a computer system, the main storage device is a hard disk. The hard disk has an advantage of large storage capacity. However, the access speed of the hard disk is much slower than that of the memory unit 74. Hence, when the CPU needs to access a great quantity of data from the hard disk, it cannot achieve a sufficient access speed due to the limitations of the transmission bandwidth of the IED interface 722 and the mechanical access architecture of the hard disk. Thus, the overall operative efficiency of the computer is limited. Furthermore, the hard disk is usually used to store the necessary data for booting the computer. Due to the slow access speed of the hard disk, the booting time of the computer is very long.

### SUMMARY OF THE INVENTION

An objective of the present invention is to provide a data transmission device and a method for the same that can be used to adjust the transmission bandwidth flexibly. The present invention can be used to avoid storing data in a single storage device, and to increase the bandwidth of the interface to increase the data transmission rate and the booting speed of a computer system.

For reaching the objective above, the present invention provides a data transmission device, which is applied to communicate with a chip set of a computer system. The data transmission device includes a first storage device, a second storage device and a transmission control unit. The transmission control unit is connected electrically to the first storage device and the second storage device. The transmission control unit is used to control the operation of data transfer between the chip set, the first storage device, and the second storage device. When the data transfer operation is performed between the chip set and the first storage device, the transmission control device checks whether a destination device is able to completely receive and process data sent, in which the destination device is the chip set or the first storage device. If the checking result is positive, the transmission control device immediately makes the destination device receive the data. If the checking result is negative, the transmission control device first sends a portion of the data to the destination device and temporarily stores a remaining portion of the data into the second storage device. The second storage device then sends the remaining portion of the data stored in the second storage device to the destination device. The interface of the transmission control unit and the chip set is a PCI-Express (PCI-E) interface.

For reaching the objective above, the present invention provides a data transmission method, which is applied to communicate with a chip set of a computer system. The data transmission method includes the following steps. A transmission control unit is provided, and which controls the chip set to send data to a first storage device. The transmission control unit is used to receive the data sent from the chip set. The transmission control unit is used to check whether the first storage device is able to receive and process the data sent from the chip set completely. If the checking result is positive, the first storage device is used to receive the data sent from the chip set directly under the control of the transmission control unit. If the checking result is negative, a first portion of the data is temporarily stored in a second storage device, a second portion, i.e. a remaining portion, of the data is directly sent to the first storage device, and then the first portion of the data temporarily stored in the second storage device is sent to the first storage device after the first storage device finishes receiving and processing the second portion of the data.

For reaching the objective above, the present invention also provides method for speedily booting a computer system. The method includes the following steps. A transmission control unit connecting a chip set with a memory unit is provided. The transmission control controls operation of data transfer between the chip set and the memory unit, in which memory unit the necessary booting data is stored. The chip set is used to access the necessary booting data from the memory unit via the transmission control unit when the computer system is switched on. When the computer system is switched off, the memory unit obtains electricity from a backup power supply. However, when the computer system is switched on, the memory unit obtains electricity from a main power supply of the computer system.

In the data transmission device and method of the present invention, when data are transferred between the chip set and the first storage device, the transmission control unit checks the data receiving speed of the destination device in advance and then flexibly stores a portion of the data in the second storage device. Hence, even though the data receiving speed of the destination device is not sufficient, the overall transmission efficiency of the computer system is not affected. In addition, since the interface of the transmission control interface and the chip set is a PCI-Express (PCI-E) interface, the transmission bandwidth is increased. Moreover, since the necessary booting device can be stored in the second storage device, i.e. a memory unit, it is not necessary to access the booting data from the hard disk but directly from the memory unit connected to the transmission control unit. Thus, the booting speed of the computer system is increased.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a block diagram of a conventional computer;

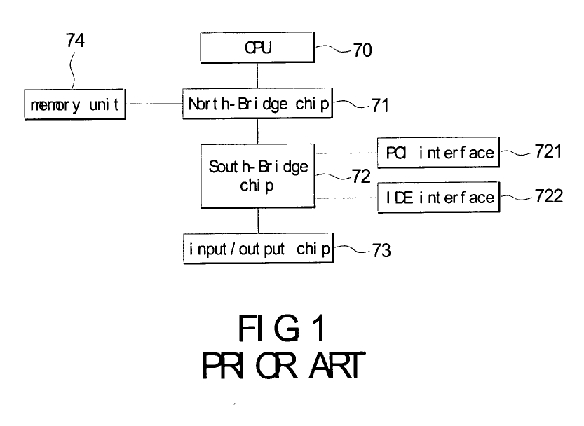

FIG. 2 is a block diagram of a preferred embodiment in accordance with the present invention;

FIG. 3 is a flow chart showing a data transfer procedure in accordance with the present invention;

FIG. 4 is a flow chart showing another data transfer procedure in accordance with the present invention; and

FIG. 5 is a flow chart showing a procedure for switching on/off a computer system in accordance with the present invention.

### DETAILED DESCRIPTION OF PREFERRED EMBODIMENTS

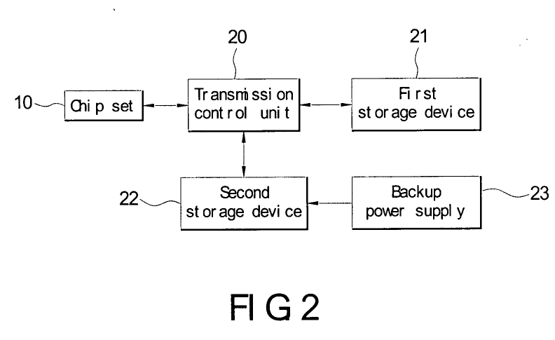

Reference is made to FIG. 2, which is a block diagram of a preferred embodiment in accordance with the present invention. A chip set 10 provided in the present invention includes a PCI-Express (PCI-E) interface and a South-Bridge or North-Bridge chip set. The chip set 10 is connected electrically to a transmission control unit 20. The transmission interface between the transmission control unit 20 and the chip set 10 is the PCI-E interface. Furthermore, the transmission control unit 20 integrates multiple PCI-E lanes to increase transmission bandwidth and data processing speed. The transmission control unit 20 is a chip in this embodiment.

The transmission control unit 20 is connected respectively to a first storage device 21 and a second storage device 22 and used to control the data transfer among the chip set 10, the first storage device 21 and the second storage device 22. For example, via the transmission control unit 20, the data may be transferred from the chip set 10 to the first storage device 21 or from the first storage device 21 to the chip set 10. The second storage device 22 provides storage space to store temporarily the data when the data transfer is performed. Thus, via the second storage device 22, the transmission control unit 20 can adjust the transmission bandwidth flexibly during the data transfer.

In this embodiment, the first storage device 21 can be a hard disk with an IDE, SATA, 1394 or SCSI interface. The second storage device 22 is a memory unit having an access speed larger than the hard disk has. During data transfer, the transmission control unit 20 checks the condition of the data reception. If the destination device is busy or cannot provide a sufficient receiving rate, the transmission control unit 20 temporarily stores the data in the second storage device 22, i.e. the memory unit. The destination device mentioned in this embodiment is the chip set 10 or the first storage device 21.

Therefore, via the transmission control unit 20, the present invention can connect with a hard disk that has a large storage capacity and a memory unit that has a higher data access rate. The hard disk and the memory unit are the first storage device 21 and the second storage device 22 mentioned in this embodiment, respectively. The second storage device 22 of this embodiment is a memory unit plugged in a memory socket of a motherboard extended for and connected to the transmission control unit 20. In accordance with the quantity of data requiring transmission, this embodiment can have multiple first storage devices 21 and multiple second storage devices 22 to increase the data transmission rate.

In this embodiment, the interface between the chip set 10 and the transmission control unit 20 is a PCI-E interface; PCI-Ex1 means that the interface has a transmission lane having a transmission rate of 250 MB/S. The PCI-E interface has various standards, such as PCI-Ex1, PCI-Ex2, PCI-Ex4, PCI-Ex8, PCI-Ex16 and PCI-Ex32. In a duplex transmission mode, for example, the PCI-Ex16 interface has a transmission rate of 8 GB/S, which is much higher than the access speed of a common memory unit or hard disk. Based on this fact, in this embodiment, the basic input/output system (BIOS) of a computer system can be set to use the second storage unit 22 for booting. The necessary data for booting can be stored in the second storage unit 22 in advance. In this way, the computer system can have a faster booting operation. In order to prevent the data stored in the second storage unit 22 from being removed when the computer system is turned off, this embodiment has a backup power supply to provide electricity for the second storage unit 22 when the computer system is turned off. The necessary data for booting can be multiple booting files, multiple registration files, multiple executive files or multiple associated files of an operating system (OS), such as the Windows system, the OS2 system or the Linux system. The necessary data for booting can also be a booting image file.

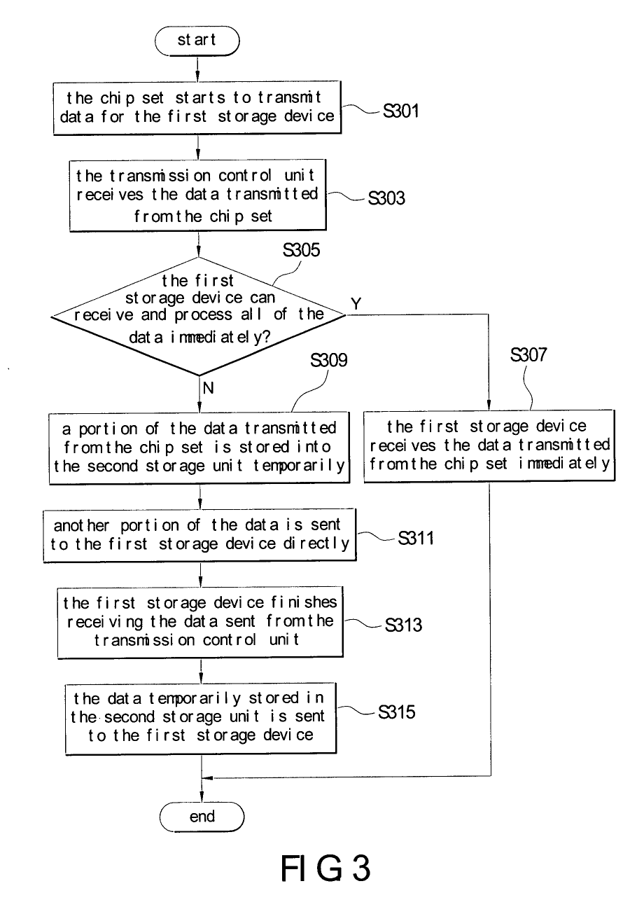

Reference is made to FIG. 3, which is a flow chart showing a data transfer procedure in accordance with the present invention. FIG. 3 shows the procedure of the data transfer from the chip set 10 to the first storage device 21 controlled by the transmission control unit 20. The data transfer procedure has the following steps. At the beginning, the chip set 10 starts to transmit data for the first storage device 21 (S301). Then, the transmission control unit 20 receives the data transmitted from the chip set 20 (S303). The transmission control unit 20 determines whether the first storage device 21 can receive and process all of the data immediately (S305); in other words, the transmission control unit 20 checks whether the data quantity that can be received and processed by the first storage device 21 exceeds that of the data transmitted from the chip set 10.

If the result of the determination is yes, the first storage device 21 immediately receives the data transmitted from the chip set 10 (S307). Otherwise, the transmission control unit 20 temporarily stores a portion of the data transmitted from the chip set 10 into the second storage unit 22 (S309) and directly sends the remaining portion to the first storage device 21 (S311). After the first storage device 21 finishes receiving the portion of data sent from the transmission control unit 20 (S313), the portion of data temporarily stored in the second storage unit 22 is then sent to the first storage device 21 (S315).

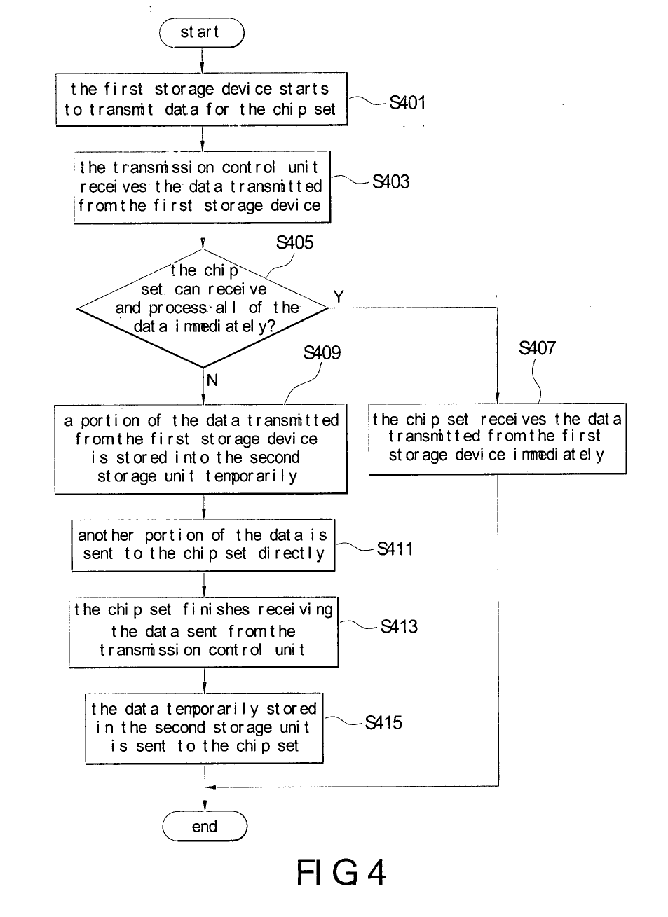

Reference is made to FIG. 4, which is a flow chart showing another data transfer procedure in accordance with the present invention. FIG. 4 shows the procedure of the data transfer from the first storage device 21 to the chip set 10 controlled by the transmission control unit 20. The data transfer procedure has the following steps. At the beginning, the first storage device 21 starts to transmit data for the chip set 10 (S401). Then, the transmission control unit 20 receives the data transmitted from the first storage device 21 (S403). The transmission control unit 20 determines whether the chip set 10 can immediately receive and process all of the data (S405); in other words, the transmission control unit 20 checks whether the data quantity that can be received and processed by the chip set 10 exceeds that of the data transmitted from the first storage device 21, and whether the chip set 10 is not busy.

If the result of the determination is yes, the chip set 10 immediately receives the data transmitted from the first storage device 21 (S407). Otherwise, the transmission control unit 20 temporarily stores a portion of the data transmitted from the first storage device 21 into the second storage unit 22 (S409) and directly sends the remaining portion to the chip set 10 (S411). After the chip set 10 finishes receiving the portion of data sent from the transmission control unit 20 (S413), the portion of data temporarily stored in the second storage unit 22 is then sent to the chip set 10 (S415).

Accordingly, the transmission control unit 20 provided in this embodiment can control the data transfer between the chip set 10 and the first storage device 21 according to the quantity of data transmitted. When the quantity of data is smaller than that able be received and processed by the destination device, the destination device directly receives the transmitted data. Otherwise, when the quantity of data is larger than that able be received and processed by the destination device, only a portion of the data that can be received and processed by the destination device is transmitted. The remaining portion of the data is temporarily stored in the second storage device 22. After the destination device finishes receiving and processing the data sent from the transmission control unit 20, the remaining portion of the data is sent from the second storage device 22 to the destination device. Since the second storage device is provided to store the data temporarily, thus providing a function similar to that of a cache memory, the transmission rate of the data transferred between the chip set 10 and the first storage device 21 is improved.

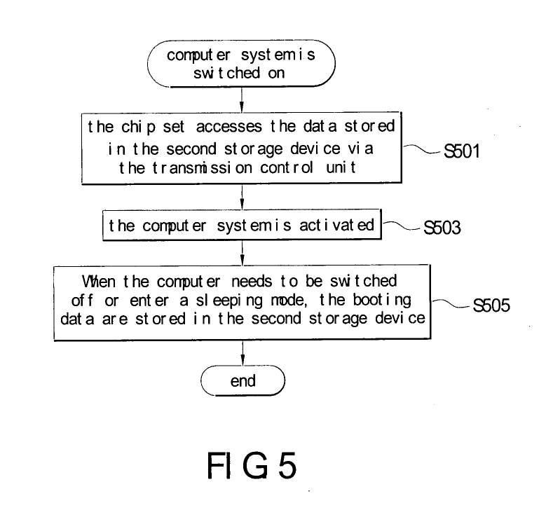

Reference is made to FIG. 5, which is a flow chart showing a procedure for switching on/off a computer system in accordance with the present invention. The second storage device 22 stores necessary booting data in advance. Hence, when the computer system is switched on, the chip set 10 accesses the necessary booting data stored in the second storage device. 22 via the transmission control unit 20 (S501). Thus, the necessary booting data can be accessed speedily. According to the data, the computer system is activated (S503). The method for booting the computer system provided in this embodiment is faster than the conventional method where the booting data must be acquired from a hard disk. When the computer needs to be switched off or enter a sleeping mode, the booting data are stored in the second storage device in advance (S505). Hence, the next time the computer system is switched on, the booting data can be accessed from the second storage device 22 directly.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

1. A method for speedily booting a computer system, comprising: providing a transmission control unit connecting a chip set with a memory unit, the transmission control controlling operation of data transfer between the chip set and the memory unit, wherein the memory unit has necessary booting data stored therein and obtains electricity from a power supply; and using the chip set to access the necessary booting data from the memory unit via the transmission control unit.

2. The method as claimed in claim 1, wherein an interface of the transmission control unit and the chip set is a PCI-E interface.

3. The method as claimed in claim 1, wherein the necessary booting data include multiple booting files, multiple registration files, multiple executive files or multiple associated files of an operating system (OS) or includes a booting image file.

4. The method as claimed in claim 1, further comprising: setting a basic input/output system (BIOS) of the computer system to use the memory unit for booting.

5. The method as claimed in claim 1, further comprising: storing the necessary booting data in the memory unit when the computer system needs to be switched off or enter a sleeping mode.
